(19) United States
(12) Patent Application Publication
(10) Pub. No.: US 2014/0367111 A1
(43) Pub. Date: Dec. 18, 2014

(54) WETTABILITY ALTERING GELLABLE TREATMENT FLUIDS

(71) Applicant: Halliburton Energy Services, Inc., Houston, TX (US)

(72) Inventors: Pubudu H. Gamage, Katy, TX (US); William Walter Shumway, Spring, TX (US); Jay Paul Deville, Spring, TX (US)

(21) Appl. No.: 13/916,086

(22) Filed: Jun. 12, 2013

(51) Int. Cl. C09K 8/88; E21B 43/26

(52) U.S. Cl. CPC C09K 8/882; E21B 43/26; C09K 2208/00
USPC 166/308.5; 507/225

(57) ABSTRACT

Gellable treatment fluids containing an acrylamide copolymer and a suitable surfactant can be used in various subterranean operations where it is necessary for the treatment fluid to remain in a gelled state for extended periods of time at high formation temperatures. The surfactants are chosen to increase the relative permeability of the hydrocarbons in the subterranean formation by wettability alteration.

### FIELD OF THE INVENTION

The present invention generally relates to the use of gellable treatment fluids in subterranean operations, and, more specifically, to the use of gellable treatment fluids that can remain in a gelled state for an extended period of time at high formation temperatures.

### BACKGROUND OF THE INVENTION

Treatment fluids can be employed in a variety of subterranean operations. As used herein the terms “treatment,” “treating,” and grammatical equivalents thereof refer to any subterranean operation that uses a fluid in conjunction with performing a desired function and/or for achieving a desired purpose. Illustrative subterranean operations that can be performed using treatment fluids can include, for example, drilling operations, fracturing operations, sand control operations, gravel packing operations, acidizing operations, conformance control operations, fluid diversion operations, fluid blocking operations, and the like.

In many cases, treatment fluids can be utilized in a gelled state when performing a treatment operation. For example, in a fracturing operation, a treatment fluid can be gelled to increase its viscosity and improve its ability to carry a proppant or other particulate material. In other cases, a gelled treatment fluid can be used to temporarily divert or block the flow of fluids within at least a portion of a subterranean formation. In the case of fracturing operations, the gelled treatment fluid typically spends only a very short amount of time downhole before the gel is broken and the treatment fluid is produced from the wellbore. In fluid diversion or blocking operations, the gel typically needs to remain in place only for a short amount of time while another treatment fluid is flowed elsewhere in the subterranean formation.

When conducting subterranean operations, it can sometimes become necessary to block the flow of fluids in the subterranean formation for a prolonged period of time, typically for at least about one day or more. In some cases, the period of time can be much longer, days or weeks. For example, it can sometimes be desirable to impede the flow of formation fluids for extended periods of time by introducing a kill pill or perforation pill into the subterranean formation to at least temporarily cease production. As used herein, the terms “kill pill” and “perforation pill” refer to a small amount of a treatment fluid introduced into a wellbore that blocks the ability of formation fluids to flow into the wellbore. In kill pill and perforation pill applications, high density brines can be particularly effective as a carrier fluid, since they can be formulated to form a highly viscous gel that blocks the flow of fluids within the wellbore by exerting hydrostatic pressure therein. Likewise, in fluid loss applications, it can sometimes be desirable to form a barrier within the wellbore that persists for an extended period of time.

Gelled treatment fluids typically remain in a stable gelled state only for a finite period of time before they break into lower viscosity fluids. In many cases, the decomposition of a gel can be accelerated by using a breaker, if a faster break is desired. For subterranean operations requiring extended downhole residence times, many gelled treatment fluids can prove unsuitable since they can break before their intended downhole function is completed. The premature break of gelled treatment fluids can be particularly problematic in high temperature subterranean formations (e.g., formations having a temperature of about 275° F. or above) where the elevated formation temperature decreases the gel stability and speeds gel decomposition. As subterranean operations are being conducted in deeper wellbores having ever higher formation temperatures, the issues with long-term gel stability are becoming an increasingly encountered issue as existing gels are being pushed to their chemical and thermal stability limits. Premature breaking can be particularly problematic in high temperature applications of biopolymer-based gellable treatment fluids (e.g., guar- and cellulose-based treatment fluids and the like), where thermally induced chain scission and molecular weight loss can accelerate gel breaking.

Synthetic gellable polymers having increased thermal stability have sometimes been used in place of biopolymers to extend the working temperature range of gellable treatment fluids. One issue with synthetic gellable polymers is that they can sometimes become crosslinked too rapidly or become overly crosslinked during gelling. If crosslinking occurs too rapidly, downhole introduction of the gellable treatment fluids can be complicated due to high friction pressures as the gel becomes too thick to effectively pump before reaching its intended location. If the gel becomes overly crosslinked, the gel can be too viscous, difficult to break and sometimes exhibit excessive syneresis whereby carrier fluid is exuded from the gel.

### SUMMARY OF THE INVENTION

In accordance with one embodiment of the present invention there is provided a treatment fluid for subterranean formations comprising an aqueous carrier fluid; a crosslinking agent; an acrylamide copolymer; and a relative permeability modifier.

In accordance with another embodiment of the present invention there is provided a process for formulating a kill pill for a subterranean formation comprising:
adding an acrylamide copolymer to an aqueous carrier fluid while mixing to produce a first mixture;
adjusting the pH of the first mixture to from 2 to 4 to produce a pH adjusted mixture;
mixing in a crosslinking agent to said pH adjusted mixture to produce a second mixture; and
mixing into said second mixture a relative permeability modifier, wherein said relative permeability modifier comprises a surfactant selected from the group consisting of alkyl amidopropyl amine betaines, alkyl betaines, alkyl amine oxides and combinations thereof, wherein said alkyl of said surfactant in the group is selected from the group consisting of decyl, cocoyl, lauryl, cetyl and oleyl.

In accordance with yet another embodiment of the present invention there is provided a method of treating a subterranean formation comprising:
providing a treatment fluid comprising an aqueous carrier fluid, a crosslinking agent, an acrylamide copolymer, and a relative permeability modifier comprising a surfactant selected from the group consisting of alkyl amidopropyl amine betaines, alkyl betaines, alkyl amine oxides and combinations thereof, wherein the alkyl of said surfactant in the group is selected from the group consisting of decyl, cocoyl, lauryl, cetyl and oleyl;
introducing the treatment fluid into a subterranean formation;
allowing the treatment fluid to form a gel in the subterranean formation; and
breaking the gel after it has been in the subterranean formation for at least about one day.

### BRIEF DESCRIPTION OF THE DRAWINGS

FIG. 1 is a graphical illustration of the permeability of sandstone exposed to a drilling fluid for both an untreated sample and sample treated with a relative permeability modifier in accordance with the current invention.

### DETAILED DESCRIPTION OF EXEMPLARY EMBODIMENTS

It has been discovered that one problem with the use of gellable polymers in kill pills is that they can leak small amounts of fluid into the formation during the hold off time. The leaked fluid can increase the water saturation in the formation, which can lower the relative permeability of the hydrocarbons. Unfortunately, once this has occurred it can be difficult to decrease the water saturation back to the original water saturation and to increase the relative permeability of the hydrocarbons back to the original permeability. The present invention relates to an inventive kill pill composition, which can increase the relative permeability of the hydrocarbon upon completion of the well by shifting the relative permeability curves and, hence altering the wettability of the formation surrounding the borehole with respect to hydrocarbons. This treatment has the effect of increasing well productivity in wells that employ the inventive kill pill.

The kill pill in accordance with the present invention utilizes gellable treatment fluids that form thermally stable gels in a subterranean formation that can persist for extended periods of time at high formation temperatures (e.g., greater than about 275° F.). Generally, the gellable treatment fluids can comprise an acrylamide copolymer and, more particularly, the gellable treatment fluids can comprise a terpolymer that comprises 2-acrylamido-2-methylpropanesulfonic acid, acrylamide, and acrylic acid monomer units or any of its salts and a crosslinking agent, where the terpolymer and the crosslinking agent form a gel downhole and the gellation can be initiated or accelerated by the formation temperature. The crosslinking rate can be further accelerated or decelerated, as desired, by using gellation accelerators or retarders, respectively, such that the gel can be formed in a desired location within the subterranean formation. Since the treatment fluids can be introduced to the subterranean formation in an ungelled state, significant issues due to friction pressure are not typically encountered. Once in the subterranean formation, the gellable treatment fluids can form a crosslinked gel therein that does not flow under in situ stress after placement. As used herein, the term “in situ stress” refers to shearing forces present within a subterranean formation, including, for example, manmade shear produced during subterranean operations and naturally occurring shear forces present within the subterranean formation. The crosslinked gels of the current embodiments are to be distinguished from other uses of the present terpolymer in subterranean operations, where a linear gel results from treatment with the crosslinking agent, but the gel remains sufficiently fluid that it does flow under low shear stress and is readily pumped downhole. In some embodiments, formation of a crosslinked gel can be promoted by using higher concentrations of a crosslinking agent than have typically been employed with the above terpolymer. In some embodiments, the terpolymer can become fully crosslinked in the presence of a crosslinking agent. As used herein, the terms “full crosslinking,” “complete crosslinking,” and grammatical equivalents thereof will refer to an amount of crosslinking that achieves a viscosity that cannot be substantially further increased by increasing the amount of crosslinking agent.

The gels formed using the above terpolymer can have surprisingly high thermal stabilities over extended periods of time, which can make them suitable for subterranean operations in which it is desirable to at least partially block the flow of fluids in the subterranean formation for a period of days to weeks at elevated formation temperatures. In particular, in certain cases, the present treatment fluids containing the terpolymer can maintain a stable gel state for at least 20 days at a temperature of 320° F. The extended thermal stability of the gels allows the present treatment fluids to be used as kill pills and perforation pills for impeding the flow of fluids, particularly formation fluids, within a subterranean formation. In addition, the present treatment fluids can be used for long-term fluid loss control applications for similar reasons. In some embodiments, the present treatment fluids can likewise be used in workover fluid applications.

As a further advantage, gels formed from the present treatment fluids can be allowed to break at their native rate without using a breaker, if desired. In some embodiments, the native break rate of the gel can be changed by altering the composition of the gel formulation in the absence of a breaker. In alternative embodiments, a breaker or delayed-release breaker can be used to break the gel. Accordingly, the present treatment fluids can be utilized over a wide range of times in subterranean operations.

In accordance with some embodiments of the present invention there is provided a gellable treatment fluid for use as a kill pill in subterranean formations comprising an aqueous carrier fluid; a crosslinking agent; an acrylamide copolymer; and a relative permeability modifier. The relative permeability modifier can be a surfactant capable of increasing the relative permeability of the hydrocarbon into the formation surrounding the borehole. Suitable surfactants include ones comprising at least one compound selected from the group consisting of alkyl amidopropyl amine betaines, alkyl betaines and alkyl amine oxides wherein the alkyl is selected from the group consisting of decyl, cocoyl, lauryl, cetyl and oleyl.

The aqueous carrier fluid of the present embodiments can generally comprise fresh water, acidified water, salt water, seawater, brine, or an aqueous salt solution. In some embodiments, the aqueous carrier fluid can comprise monovalent brine or divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like. In some embodiments, the aqueous carrier fluid can be a high density brine. As used herein, the term “high density brine” refers to a brine that has a density of about 10 lbs/gal or greater (1.2 g/cm3 or greater). It is believed that the formation of gels in such high density brines can be particularly problematic due to polymer hydration issues. However, gelled treatment fluids formed from high density brines can be particularly advantageous for kill pill and other fluid loss applications due to the significant hydrostatic pressure exerted by the weight of the gel. Presently, sodium bromide brine is preferred for use as the aqueous carrier fluid.

The acrylamide copolymer used in the present embodiments can have a composition spanning a wide range. In general, where the acrylamide copolymer is a terpolymer that comprises 2-acrylamido-2-methylpropanesulfonic acid, acrylamide and acrylic acid monomer units, the amount of 2-acrylamido-2-methylpropanesulfonic acid monomer units in the terpolymer can range from about 10% to about 80% of the terpolymer by weight, and the amount of acrylic acid monomer units in the terpolymer can range from about 0.1% to about 10% of the terpolymer by weight, with the balance comprising acrylamide monomer units. In more particular embodiments, the terpolymer can comprise from 55% to 65% 2-acrylamido-2-methylpropanesulfonic acid monomer units by weight, from 34.9% to 44.9% acrylamide monomer units by weight, and from 0.1% to 10.1% acrylic acid monomer units by weight. In still more particular embodiments, the terpolymer can comprise from 55% to 65% 2-acrylamido-2-methylpropanesulfonic acid monomer units by weight, from 34.9% to 49.9% acrylamide monomer units by weight, and from 0.1% to 5.1% acrylic acid monomer units by weight.

In various embodiments, an amount of the terpolymer in the present treatment fluids can range from about 0.1 wt. % to about 10 wt. % relative to the water of the treatment fluid. In some embodiments, an amount of the terpolymer can range from 0.9 wt. % to 5 wt. % relative to the water of the treatment fluid. In some embodiments, an amount of the terpolymer can range from 2.5 wt. % to 3.2 wt. % relative to the water of the treatment fluid.

A variety of crosslinking agents can be used in accordance with the present embodiments. In some embodiments, the crosslinking agent can be a metal ion. Metal ions suitable to serve as crosslinking agents in the present embodiments can include, for example, titanium (IV) ions, zirconium (IV) ions, chromium (III) ions, cobalt (III) ions, aluminum (III) ions, hafnium (III) ions, and the like. In some embodiments, zirconium derived crosslinking agents are preferred, such as crosslinking agents comprised of zirconyl chloride or zirconyl sulfate. In some embodiments, a metal ion-releasing compound such as a coordination compound can be used. In some embodiments, the crosslinking agent can be an organic crosslinking agent such as, for example, a diamine, dithiol or a diol. In some embodiments, the crosslinking agent can be an organic polymer such as, for example, a polyester, a polyalkyleneimine (e.g., polyethyleneimine) or a polyalkylenepolyamine. Having the benefit of the present disclosure and knowing the temperature and chemistry of a subterranean formation of interest, one having ordinary skill in the art will be able to choose a crosslinking agent and amount thereof suitable for producing a desired gel time and viscosity.

In some embodiments, mixtures of crosslinking agents can be used to achieve a desired rate of crosslinking. For example, in some embodiments, a crosslinking agent that produces a slower rate of crosslinking can be added as a gellation retarder, and in other embodiments, a crosslinking agent that produces a faster rate of crosslinking can be added as a gellation accelerator. In some embodiments, a gellation retarder or a gellation accelerator can, respectively, increase or decrease the temperature at which gellation takes place. In some embodiments, a metal ion-containing crosslinking agent can contain various concentrations of acetate and lactate, which will determine whether the added crosslinking agent serves as a gellation retarder or a gellation accelerator. Appropriate amounts of acetate and lactate ions to be added to a metal ion-containing crosslinking agent to serve as either a gellation retarder or gellation accelerator can be determined through routine experimentation by one having ordinary skill in the art. Other agents that can be added to control the rate and/or temperature of gellation can include, for example, other α-hydroxy acids (e.g., glycolic acid, tartaric acid and the like), diols and polyols.

Generally, the crosslinking agent is present in the current treatment fluids in an amount sufficient to provide a desired degree of crosslinking of the terpolymer. In some embodiments, the amount of crosslinking agent present can be sufficient to achieve complete crosslinking, although incomplete crosslinking may be more preferable in other embodiments. In some embodiments, an amount of the crosslinking agent in the treatment fluid can be at least about 5 wt. % relative to the water in the treatment fluid. In other embodiments, an amount of the crosslinking agent can be at least 2 wt. % relative to the water in the treatment fluid. In still other embodiments, an amount of the crosslinking agent in the treatment fluid can be at least 1.10 wt. % relative to the water in the treatment fluid. In some embodiments, an amount of the crosslinking agent can range from about 1 wt. % to about 2 wt. % relative to the water in the treatment fluid or from 1 wt. % to 1.6 wt. % relative to the water in the treatment fluid.

In order to form a gel having a suitable temperature stability and viscosity profile, an amount of the terpolymer to the crosslinking agent is typically maintained at a concentration ratio of at most about 10:1. In some embodiments, an amount of the terpolymer to the crosslinking agent can be maintained at a concentration ratio of at most 6:1. In one embodiment the concentration ratio of terpolymer to crosslinking agent can be about 3:1 but in some embodiments, a concentration ratio of the terpolymer to the crosslinking agent can range from 6:1 to 2:1. In other embodiments, a concentration ratio of the terpolymer to the crosslinking agent can range from about 6:1 to about 1:1.

The inventive kill pill composition contains a relative permeability modifier. As outlined above, the leakage of fluids into a wellbore during perforation, workover, or other completion operations is a substantial concern. These concerns are elevated in high temperature wells where fluids can leak from the kill pill into the subterranean formation and have an adverse effect on hydrocarbon permeability. In accordance with the current invention, it has been found that the incorporation of a suitable relative permeability modifier helps to maintain the hydrostatic integrity of the wellbore during these aforementioned operations. The relative permeability modifier can include a suitable surfactant and, optionally, a co-surfactant. Suitable surfactants are ones capable of increasing the relative permeability of the hydrocarbon into the formation surrounding the borehole upon completion of the well by shifting the relative permeability curves associated with the formation. Suitable surfactants can generally be selected from the group consisting of alkyl amidopropyl betaines, alkyl betaines and alkyl amine oxides and combinations thereof wherein the alkyl is selected from the group consisting of decyl, cocoyl, lauryl, cetyl and oleyl. More specifically, suitable surfactants can be selected from the group consisting of laurylamidopropyl betaine; lauryl betaine, lauryl amine oxide, and combinations thereof. Incorporation of the relative permeability modifier in the kill pill yields benefits when fluid, which contains all or portions of the relative permeability modifier, is extruded from the pill into the formation. While not wishing to be bound by theory, it is believed that this benefit comes from the surfactants and/or co-surfactants in the relative permeability modifier positively affecting relative permeability to the formation fluids by wettability alteration and interfacial tension alteration of the subterranean formation.

The relative permeability modifier can comprise an alcohol co-surfactant. Typically, the alcohol will be an alcohol having from 2 to 10 carbon atoms, with acyclic alcohols being preferred and alkyl alcohols being more preferred. Butanol is exemplary of a suitable alcohol. If alcohol is used as a co-surfactant, generally the relative permeability modifier can be introduced into the kill pill as a mixture. Typically, the mixture can have the surfactant in a solution of the alcohol co-surfactant or as a microemulsion with the alcohol co-surfactant. The surfactant can make up from about 10 wt. % to about 80 wt. % of the mixture and in some embodiments from 25 wt. % to about 40 wt. % of the mixture.

The amount of the relative permeability modifier, including alcohol co-surfactant, can be at least about 0.5 wt. % relative to water in the treatment fluid. In other embodiments, the amount of the surfactant in the treatment fluid can be at least 1 wt. % relative to water in the treatment fluid. In some embodiments, the amount of the surfactant can range between about 0.5 wt. % and about 10 wt. % relative to water in the treatment fluid or from 1 wt. % and 5 wt. % relative to water in the treatment fluid.

In some embodiments, treatment fluids described herein can comprise a gel stabilizer such as, for example, one or more antioxidants. When the formation temperature is high and/or when the gel formed from the treatment fluid is allowed to remain in the subterranean formation for extended periods of time, it can be especially beneficial to include one or more antioxidants in the treatment fluid to maintain the rheological and chemical stability of the gel. Without being bound by any theory or mechanism, it is believed that inclusion of an antioxidant in the treatment fluids can limit oxidative damage to the terpolymer that can otherwise occur over extended periods of time at high temperatures. Oxidative damage can include polymer chain scission, for example, which can reduce the ability of the terpolymer to form a gel. In some cases, extended exposure to high temperatures can be damaging to the antioxidant itself, which can limit its ability to protect the terpolymer from oxidative damage.

In some embodiments, other beneficial effects of including an antioxidant can be realized as well. For example, in some embodiments, the degree of crosslinking can be altered by including or excluding certain antioxidants. If the degree of crosslinking is altered by the inclusion or exclusion of an antioxidant, the ratio of the terpolymer to the crosslinking agent can be adjusted, if desired, to achieve a desired degree of crosslinking in the gel.

In some embodiments, suitable antioxidants can include, for example, a sulfite salt (e.g., sodium sulfite), ascorbic acid, erythorbic acid, a hydroquinone, any salt thereof (e.g. sodium erythorbate), any derivative thereof, or any combination thereof. Other suitable antioxidants can be envisioned by one having ordinary skill in the art. For example, in some embodiments, other suitable antioxidants can include, for example, tannic acid, gallic acid, propyl gallate, thiols, and the like. In some embodiments, certain antioxidants can themselves be degraded by extended residence times in high temperature subterranean formations. In some embodiments, an antioxidant containing ascorbic acid, erythorbic acid, any salt thereof, any derivative thereof, or any combination thereof can be further combined with a hydroxylamine to further increase its temperature stability. In some embodiments, a suitable hydroxylamine compound for use in high temperature subterranean formations can be isopropylhydroxylamine. It is to be recognized that other hydroxylamine compounds can also be used in place of isopropylhydroxylamine, if desired. Generally, it is contemplated that any hydroxylamine compound having a molecular weight of less than about 400 can be used in the present embodiments. When used, a ratio of the hydroxylamine compound to the ascorbic acid and/or erythorbic acid, or salt or derivative thereof, can range between about 1:1 and about 3:1. In some embodiments, the hydroxylamine compound and the ascorbic acid and/or erythorbic acid, or salt or derivative thereof, can be blended in an aqueous fluid.

In addition to the foregoing materials, it can also be desirable, in some embodiments, for other components to be present in the treatment fluid. Such additional components can include, without limitation, particulate materials, fibrous materials, bridging agents, weighting agents, proppants, gravel, corrosion inhibitors, catalysts, clay control stabilizers, biocides, bactericides, friction reducers, gases, solubilizers, salts, scale inhibitors, corrosion inhibitors, foaming agents, anti-foaming agents, iron control agents, and the like.

In some embodiments, the present treatment fluids can have a pH ranging from about 1 to about 6 prior to gel formation occurring. In other embodiments, the treatment fluids can have a pH ranging from about 3 to about 5. In still other embodiments, the treatment fluids can have a pH ranging from 2 to 4.8 or from 4.2 to 4.8. In some embodiments, the present treatment fluids can further comprise a buffer to maintain the pH of the treatment fluid within a desired range, including within any of the above ranges. When used, the buffer should be chosen such that it does not interfere with the formation of a gel within the subterranean formation. In various embodiments, a concentration of the buffer can range between about 0.1 wt. % and about 1 wt. % of the treatment fluid. In some embodiments, the pH of the treatment fluid can be further adjusted with a pH-modifying agent such as, for example, an acid or a base. Reasons why one would want to adjust the pH of the treatment fluid can include, for example, to adjust the rate of hydration of the terpolymer, to activate the crosslinking agent, to improve the properties of the gel formed from the copolymer, to adjust the rate of gellation of the terpolymer, and any combination thereof. In addition, the pH of the treatment fluid can influence the rate at which breakers, particularly delayed-release breakers, are operable to break the gel formed from the terpolymer.

In high temperature formations having a temperature of about 280° F. or greater, the present treatment fluids can undergo gellation simply by exposure to the formation temperatures. In subterranean formations having a temperature of about 200° F. to about 275° F., it can be more desirable, and often necessary, to accelerate the gellation rate by formulating the crosslinking agent as a gellation accelerator. At these lower temperatures, the gellation rate can either be sluggish, or a gel can fail to form. In such lower temperature formations, divalent brines can be particularly suitable for forming the gellable treatment fluid. Divalent brines, but not monovalent brines, can sometimes be incompatible with the terpolymer due to precipitation and other instability issues, particularly as the formation temperature approaches and exceeds 300° F. Under these conditions, the gel can experience mechanical failure in a very short time in the presence of a divalent brine. At lower formation temperatures (e.g., less than about 250° F.), however, divalent brines can be successfully used with the terpolymer without substantial precipitation occurring. As previously noted, crosslinking can be extremely slow to non-existent at these lower temperatures. Use of a gellation accelerator to accelerate the crosslinking rate can enable the use of divalent brines in these embodiments.

In some embodiments, the present methods can comprise breaking the gel in the subterranean formation, most typically after the gel has been in the subterranean formation for at least about one day. In some embodiments, the treatment fluid can be formulated such that the gel breaks at the formation temperature at a desired time. That is, in such embodiments, the gel can be broken without adding a breaker or including a breaker in the treatment fluid. Knowing the temperature and chemistry of the subterranean formation, one having ordinary skill in the art and the benefit of the present disclosure will be able to formulate a treatment fluid having a desired break time.

In other embodiments, the present methods can further comprise treating the gel with a breaker. In some embodiments, the breaker can be added to the gel within a separate treatment fluid. A wide variety of suitable breakers are well known to one having ordinary skill in the art. In some embodiments, the breaker can be an oxidizer such as, for example, sodium bromate, sodium chlorate, ammonium persulfate or manganese dioxide. In some embodiments, the breaker can comprise a treatment fluid having a pH of about 7 or greater, which can cause gels formed from the present treatment fluids to collapse. In some embodiments, the breaker can be present in the treatment fluid as a delayed-release breaker. In some embodiments, a breaker can be formulated for delayed release by encapsulating the breaker in a material that is slowly soluble or slowly degradable in the treatment fluid or the gel formed therefrom. Illustrative materials that can be used for encapsulation can include, for example, porous materials (e.g., precipitated silica, alumina, zeolites, clays, hydrotalcites, and the like), EPDM rubber, polyvinylidene chloride, polyamides, polyurethanes, crosslinked and partially hydrolyzed acrylate polymers, and the like. In some embodiments, degradable polymers can be used to encapsulate a breaker. In some embodiments, a suitable breaker for use with the present treatment fluids can be “VICON FB” or HT Breaker,” which are breakers available from Halliburton Energy Services, Inc.

Although the gelled treatment fluids of the current invention can be used in subterranean formations having lower temperatures generally, they are especially useful in subterranean formations having temperatures of 275° F. or above. In some embodiments, the present treatment fluids can be used in subterranean formations having temperatures up to about 400° F. In some embodiments, the present treatment fluids can be used in a subterranean formation having a temperature ranging from 300° F. to 350° F.

Depending on the function that the present treatment fluids are performing, one having ordinary skill in the art will be able to determine an appropriate length of time for the gel to remain in the subterranean formation prior to being broken. The present treatment fluids are particularly useful in applications that require the gel to remain unbroken for relatively long periods of times and can remain in the subterranean for from about one day to about thirty days prior to being broken. Typical applications will be from one day to fifteen days prior to being broken. In some subterranean operations, it can be desirable to leave the gels in the subterranean formation for a shorter length of time. In some embodiments, gels formed from present treatment fluids can be allowed to remain in the subterranean formation for less than one day. For example, the gels can be allowed to remain in the subterranean formation for about 16 hours or less, or about 8 hours or less, or about 2 hours or less before being broken.

The treatment fluids of the current invention can be formed by a process comprising the steps of:
adding an acrylamide copolymer to an aqueous carrier fluid while mixing to produce a first mixture;
adjusting the pH of the first mixture to from 2 to 4 to produce a pH adjusted mixture;
mixing in a crosslinking agent to the pH adjusted mixture to produce a second mixture;
mixing in a relative permeability modifier comprising a surfactant selected from the group consisting of laurylamidopropyl betaine; lauryl betaine, lauryl amine oxide, and combinations thereof, into the second mixture to produce the kill pill; and
thereafter optionally mixing in an antioxidant and/or a stabilizer.

More specifically, an exemplary process might comprise placing a sodium bromide brine into an appropriately sized container and mixing under shear conditions so as to form a deep vortex without whipping laboratory air into the fluid. The acrylamide copolymer can then be added to the brine while it is shearing and the stirring continues until the copolymer is well dispersed in the brine. Subsequently, the pH of the mixture can be adjusted to from 2.5 to 3.0 by the addition of an appropriate acid, such as sulfamic acid, followed by the crosslinking agent being quickly added to the pH adjusted polymer mixture while stifling until fully dispersed. Next, the relative permeability modifier is added to the mixture while stifling and then adding any antioxidant, such as sodium erythorbate, and any stabilizer. Once the relative permeability modifier, antioxidant and stabilizer, are fully dispersed, the pH of the thus fully formulated pill is adjusted so that it is from 2 to 5. Different pH values for the formulation can be used depending on the required holding time for the kill pill with lower pH increasing breaking time. The pH can be adjusted by adding a suitable acid, such as sulfamic acid.

To facilitate a better understanding of the present invention, the following examples of preferred embodiments are given. In no way should the following examples be read to limit, or to define, the scope of the invention.

### EXAMPLES

### Control

Sandstone was used to test permeability. The sandstone was in the form of a 1.5 inch diameter sandstone core prepared by the following process. The core was obtained and dried for 16 hours. The core was subsequently saturated in 5 wt % NaCl under vacuum for 2 hours and soaked for 16 hours in the NaCl solution.

A brined-saturated sandstone core was prepared as above and placed into an automated return permeameter. The pressure on the core was 1000 psi at a temperature of 200° F. An isoparaffin solvent sold under the trademark SOLTROL by Chevron Phillips Chemical Company was flowed over the core at 4 mL/min until permeability was stable. The permeability was then measured.

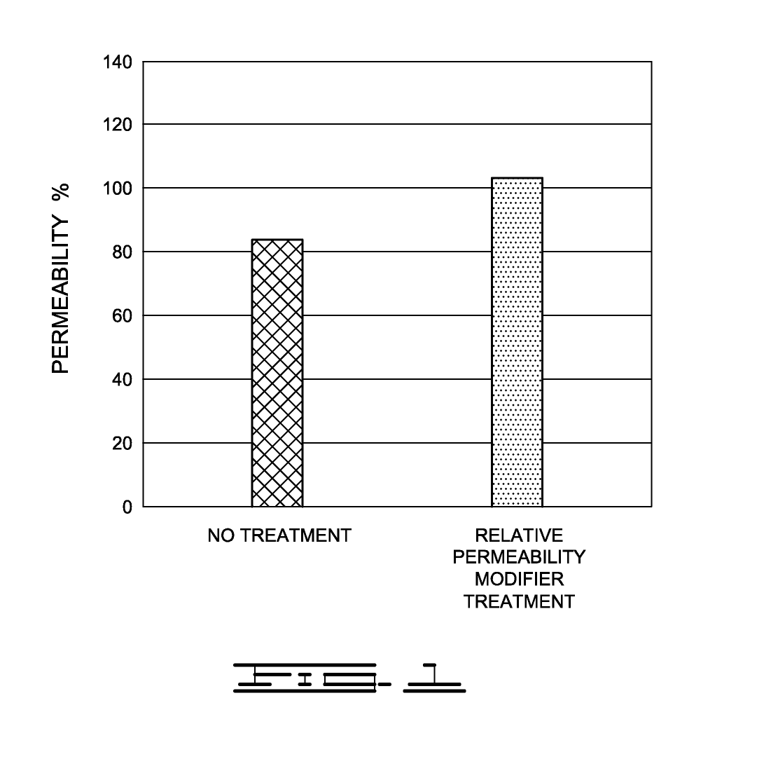

Drilling fluid was then introduced to the core. The drilling fluid was a clay-free, acid soluble reservoir drilling fluid sold under the trademark BARADRIL-N by Halliburton Energy Services, Inc. The core was run with drilling fluid with 500 psi of differential pressure for 2 hours using dynamic filtration. Subsequently, the isoparaffin solvent was flowed over the core at 4 mL/min until permeability was stable. The permeability was then measured and the permeability percentage of the prior measurement was recorded as the regain permeability. The results are shown in FIG. 1 as “No Treatment.”

### EXAMPLE 1

The process of the Control was followed except that the drilling fluid included 1.0 vol % of a lauryl betaine with butanol as a relative permeability modifier. The results are shown in FIG. 1 as “Relative Permeability Modifier Treatment”.

As can be seen from FIG. 1, the untreated sample has only about 82% of the permeability of the sandstone prior to exposure to the drilling fluid. The treated sample has over 100% of the permeability of the sandstone prior to exposure to the drilling fluid. Accordingly, the relatively permeability modifier of the current invention had the effect of increasing permeability and, hence, would increase well productivity.

### EXAMPLE 2

Example 2 illustrates the production of a treatment fluid in accordance with the invention.

A kill pill was formulated by first diluting 280 mL of 12.5 lb/gal NaBr stock brine with 420 mL of 8.345 lb/gal deionized water to produce a 10 lb/gal NABr brine. The diluted brine was placed in an appropriately sized container and sheared at moderate speed with a paddle mixer. The rotational speed of the mixer was adjusted such that it creates a deep vortex without whipping air into the fluid.

Next, 3% (v/v) or 11.1 lb/bbl of an acrylamide copolymer was slowly added to the brine while shearing. The mixture was stirred until the majority of the areas of high polymer concentration had been dispersed. Then the pH of the polymer solution was adjusted down to about 3 by addition of an aqueous sulfamic acid. Quickly after the pH adjustment, 1% (v/v) or 3.5 lb/bbl of a zirconium-derived crosslinking agent was added to the polymer solution with stirring. The viscosity of the fluid increased rapidly; accordingly, the rotation speed of the mixer was adjusted as needed to discourage the solution from climbing the mixing shaft.

Once the crosslinking agent was fully dispersed, 0.5 lb/bbl of a lauryl betaine and butanol relative permeability modifier was added. The amount of relative permeability modifier was varied depending on the formation temperature and formation wettability. Afterwards, 0.3% (v/v) or 1 lb/bbl sodium erythorbate antioxidant was added followed by 0.15% (w/v) or 0.5 lb/bbl of a sodium sulfite stabilizer, which is a sodium sulfite oxygen scavenger sold under the trademark BARASCAV D by Halliburton Energy Services, Inc.

After ensuring that the antioxidant and stabilizer were fully dispersed, the pH of the fully formulated pill was adjusted to be in the range of from 4.2 to 4.8. The pH was adjusted by adding sulfamic acid as necessary.

The resulting fully formulated pill is suitable for use as a kill pill, which will increase the relative permeability of the hydrocarbon upon completion of the well by shifting the relative permeability curves and, hence altering the wettability of the formation surrounding the borehole. Thus the kill pill will have the effect of increasing well productivity in wells that employ the inventive kill pill.

While various embodiments of the invention have been shown and described herein, modifications may be made by one skilled in the art without departing from the spirit and the teachings of the invention. The embodiments described herein are exemplary only, and are not intended to be limiting. Many variations, combinations, and modifications of the invention disclosed herein are possible and are within the scope of the invention. Accordingly, the scope of protection is not limited by the description set out above, but is defined by the claims which follow, that scope including all equivalents of the subject matter of the claims.

What is claimed is:

1. A treatment fluid for a subterranean formation comprising:
an aqueous carrier fluid;
a crosslinking agent;
an acrylamide copolymer; and
a relative permeability modifier.

2. The treatment fluid of claim 1 wherein said relative permeability modifier comprises a surfactant selected from the group consisting of alkyl amidopropyl amine betaines, alkyl betaines, alkyl amine oxides and combinations thereof, wherein said alkyl of said surfactant in the group is selected from the group consisting of decyl, cocoyl, lauryl, cetyl and oleyl.

3. The treatment fluid of claim 2 wherein said surfactant comprises at least one compound selected from the group consisting of laurylamidopropyl betaine; lauryl betaine, and lauryl amine oxide.

4. The treatment fluid of claim 2 wherein said relative permeability modifier further comprises a co-surfactant.

5. The treatment fluid of claim 4 wherein said surfactant is introduced as a solution in said co-surfactant into a mixture of said aqueous carrier fluid, crosslinking agent, gel stabilizer and acrylamide copolymer.

6. The treatment fluid of claim 4 wherein said surfactant and co-surfactant are introduced as a microemulsion into a mixture of said aqueous carrier fluid, crosslinking agent, gel stabilizer and acrylamide copolymer.

7. The treatment fluid of claim 4 wherein said co-surfactant is an alcohol.

8. The treatment fluid of claim 5 wherein said alcohol is butanol.

9. The treatment fluid of claim 1 wherein said acrylamide copolymer is a terpolymer that comprises 2-acrylamido-2-methylpropanesulfonic acid, acrylamide and acrylic acid monomer units or any salt thereof.

10. The treatment fluid of claim 9 further comprising a gel stabilizer and wherein said relative permeability modifier comprises laurylamidopropyl betaine and butanol and said laurylamidopropyl is introduced as a solution in said butanol, into a mixture of said aqueous carrier fluid, crosslinking agent, gel stabilizer and acrylamide copolymer.

11. The treatment fluid of claim 9 further comprising a gel stabilizer and wherein said relative permeability modifier comprises lauryl betaine and butanol and said lauryl betaine is introduced as a solution in said butanol into a mixture of said aqueous carrier fluid, crosslinking agent, gel stabilizer and acrylamide copolymer.

12. The treatment fluid of claim 9 further comprising a gel stabilizer and wherein said relative permeability modifier comprises lauryl amine oxide and butanol and said lauryl amine oxide is introduced as a solution in butanol into a mixture of said aqueous carrier fluid, crosslinking agent, gel stabilizer and acrylamide copolymer.

13. A process for formulating a kill pill for a subterranean formation comprising:
adding an acrylamide copolymer to an aqueous carrier fluid while mixing to produce a first mixture;
adjusting the pH of said first mixture to from 2 to 4 to produce a pH adjusted mixture;
mixing in a crosslinking agent to said pH adjusted mixture to produce a second mixture; and
mixing into said second mixture a relative permeability modifier, wherein said relative permeability modifier comprises a surfactant selected from the group consisting of alkyl amidopropyl amine betaines, alkyl betaines, alkyl amine oxides and combinations thereof, wherein said alkyl of said surfactant in the group is selected from the group consisting of decyl, cocoyl, lauryl, cetyl and oleyl.

14. The process of claim 13 further comprising, after mixing in any said relative permeability modifier, mixing in an antioxidant and a stabilizer, and thereafter adjusting the pH to be from 1 to 6.

15. The process of claim 13 wherein said surfactant comprises at least one compound selected from the group consisting of laurylamidopropyl betaine, lauryl betaine, and lauryl amine oxide, into said second mixture to produce said kill pill.

16. The process of claim 13 further comprising adjusting the pH of said kill pill after mixing in said surfactant such that said kill pill has a pH from 3 to 5.

17. The process of claim 13 further comprising mixing in a gel stabilizer after said mixing in of said surfactant.

18. The process of claim 13 wherein said relative permeability modifier further comprises a co-surfactant.

19. The process of claim 18 wherein said co-surfactant is an alcohol.

20. The process of claim 19 wherein said surfactant is in solution in said alcohol when said permeability modifier is mixed into said second mixture.

21. The process of claim 19 wherein said surfactant and said alcohol are in a microemulsion when said permeability modifier is mixed into said second mixture.

22. The process of claim 19 wherein said alcohol is butanol.

23. The process of claim 13 wherein said acrylamide copolymer is a terpolymer that comprises 2-acrylamido-2-methylpropanesulfonic acid, acrylamide and acrylic acid monomer units or any salt thereof.

24. A method of treating a subterranean formation comprising:
providing a treatment fluid comprising an aqueous carrier fluid, a crosslinking agent, an acrylamide copolymer, and a relative permeability modifier comprising a surfactant selected from the group consisting of alkyl amidopropyl amine betaines, alkyl betaines, alkyl amine oxides and combinations thereof, wherein said alkyl of said surfactant in the group is selected from the group consisting of decyl, cocoyl, lauryl, cetyl and oleyl;
introducing said treatment fluid into a subterranean formation;
allowing said treatment fluid to form a gel in said subterranean formation; and
breaking said gel after it has been in said subterranean formation for at least about one day.

25. The method of claim 24 wherein said surfactant comprises at least one compound selected from the group consisting of laurylamidopropyl betaine; lauryl betaine, and lauryl amine oxide.

26. The method of claim 24 wherein said acrylamide copolymer is a terpolymer that comprises 2-acrylamido-2-methylpropanesulfonic acid, acrylamide and acrylic acid monomer units or any salt thereof.

27. The method of claim 24 wherein said relative permeability modifier further comprises an alcohol co-surfactant.

28. The method of claim 27 wherein said alcohol is butanol.
